(19) United States
(12) Patent Application Publication
(10) Pub. No.: US 2008/0244407 A1
(43) Pub. Date: Oct. 2, 2008

(54) ABSTRACTIONS IN DISC AUTHORING

(76) Inventors: Don Eklund, Yorba Linda, CA (US); Sumit Malik, Pasadena, CA (US); Raja Sahi, Los Angeles, CA (US); Tommy Choy, Lakewood, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/467,896

(22) Filed: Aug. 28, 2006

Related U.S. Application Data
(60) Provisional application No. 60/712,684, filed on Aug. 29, 2005.

(51) Int. Cl. G06F 3/048

(52) U.S. Cl. 715/719

(57) ABSTRACT

Authoring a Blu-ray Disc, comprising: providing abstractions that offer a functionality for a user to switch views of a BD-ROM data structure based on requirements and levels of expertise of the user; and providing a mechanism to author projects independent of an underlying format compliant to a final project output format.

### RELATED APPLICATION

This application claims the benefit of priority of co-pending U.S. Provisional Patent Application Ser. No. 60/712,684, filed Aug. 29, 2005, entitled “Abstractions in Disk Authoring.” The disclosure of the above-referenced patent application is hereby incorporated by reference.

### BACKGROUND

1. Field of the Invention

The present invention relates generally to disc authoring and, more particularly, to providing abstractions in authoring optical disks such as Blu-ray Discs.

2. Related Art

A media authoring system is typically used to generate articles of media that are compliant with a particular standard. For example, a Digital Versatile Disc (DVD) authoring system is used to generate data, such as audio and video data and information used to present and access the audio and video data, on a DVD. The data on the disc is stored according to standards defined for DVD. Similarly, a Blu-ray Disc (BD) authoring system is used to create optical discs storing information according to the standards defined for BD.

### SUMMARY

Embodiments of the present invention include systems and methods to implement techniques for disc authoring using abstractions, such as in authoring optical discs compliant with Blu-ray Disc.

In one implementation, a method for authoring a Blu-ray Disc includes, providing abstractions that offer a functionality for a user to switch views of a BD-ROM data structure based on requirements and levels of expertise of is the user, and providing a mechanism to author projects independent of an underlying format compliant to a final project output format.

In one implementation, switching views of the BD-ROM data structure includes hiding different levels of underlying details of the BD-ROM data structure created by the user. In another implementation, switching views of the BD-ROM data structure includes exposing different levels of underlying details of the BD-ROM data structure created by the user.

In another implementation, a Blu-ray Disc authoring system includes, an abstraction module configured to receive BD-ROM data and provide abstractions that offer a functionality for a user to switch views of a BD-ROM data structure based on requirements and levels of expertise of the user, and a BD authoring mechanism configured to author projects independent of an underlying format compliant to a final project output format.

In an implementation, the playable content includes a title, a menu, virtual playable content, a multi-story playable content, a multi-angle playable content, a single segment time-based slideshow, a multi-segment time-based slideshow, and a browsable slideshow. In another implementation, the abstraction module is configured to provide abstraction of the playable content that represents the basic playable entity including a Movie Object, a Playlist, PlayItems, and Clips. In still another implementation, the abstraction module is configured to provide abstraction of the playable content that represents BD Java code, a Playlist, PlayItems, and Clips.

In an implementation, a computer program, stored in a computer-readable storage medium, for authoring a Blu-ray Disc, the program includes executable instructions that cause a computer to provide abstractions that offer a functionality for a user to switch views of a BD-ROM data structure based on requirements and levels of expertise of the user, and provide a mechanism to author projects independent of an underlying format compliant to a final project output format.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be understood in part by studying the accompanying drawings, in which like reference numerals refer to like parts, and in which:

FIG. 1 provides a simplified overview of the BD-ROM data structure;

FIG. 2 shows Index Table, which is a top-level table structure that defines the Titles of a BD-ROM disc;

FIG. 3 illustrates one example of a Movie Object including navigation commands that can launch Playlist playback or another Movie Object;

FIG. 4 illustrates one example of Playlists, which are a collection of playing intervals in the Clips that indicates which portion of the Clip to play and when to play the Clip;

FIG. 5 shows an example of a Playlist including one main path that provides a master presentation of the Playlist and one or more sub-paths that provide auxiliary presentations associated with the master presentation;

FIG. 6 shows the PlayItem specifying a time based playing interval from the IN-time until the OUT-time;

FIG. 7 shows an AV stream file, together with its associated database attributes, which is considered to be one object;

FIG. 8A shows playable content representing a Movie Object, a Playlist, PlayItems, and Clips;

FIG. 8B shows playable content including a video stream 830 by default;

FIG. 9A shows that a Title is generated directly using a Title object;

FIG. 9B shows that a Title includes a video stream and an audio stream by default;

FIG. 10 illustrates one example of virtual playable content;

FIG. 11 illustrates one example of a single segment time-based slideshow, which is an abstraction that represents the Time-based Slideshow object with a single PlayItem;

FIG. 12 illustrates one example of a multi-segment time-based slideshow, which is an abstraction that represents the Time-based Slideshow object with multiple PlayItems;

FIG. 13 illustrates one example of a browsable slideshow, which is an abstraction that represents the Browsable Slideshow object;

FIG. 14 illustrates one example of a segment, which is an abstraction that represents a PlayItem object in the ED-ROM format;

FIG. 15 illustrates one example of Clips, which are abstractions that represent ‘Clip’ objects in the BD-ROM format;

FIG. 16A shows a directory and sub-directories of streams;

FIG. 16B illustrates playable contents including a Video Stream, an Audio Stream, an Interactive Graphics Stream, a Presentation Graphics Stream, and a Text Subtitle Stream;

FIG. 17 illustrates one example of a Slide object, which is an abstraction that represents the video presentation unit in slideshows;

FIG. 18 illustrates one example of Menu Events, which are abstractions that represents Interactive Composition Segments;

FIG. 19 illustrates an example of objects and elements including a Page Layer Composition (PLC), a Page Layer (PL), and Buttons;

FIG. 20 illustrates an example of effects including In Effect and Out Effect;

FIG. 21 is a flowchart illustrating a method for authoring a Blu-ray Disc;

FIG. 22 is a block diagram of a BD authoring system, which receives BD-ROM data as an input and outputs an abstraction of the BD-ROM data;

FIG. 23A shows a representation of a computer system and a user; and

FIG. 23B shows a block diagram of one implementation of the computer system in FIG. 23A, including the BD authoring system.

### DETAILED DESCRIPTION

As will be further described below, embodiments of the present invention provide the need for an efficient structure and configuration in authoring articles of media that are compliant with a particular standard. In one implementation, a Blu-ray Disc (BD) authoring system executes instructions to store information based on the BD standard specifications using abstractions. After reading this description it will become apparent to one skilled in the art how to implement the invention in various embodiments and applications. However, although various embodiments of the present invention will be described herein, it is understood that these embodiments are presented by way of example only, and not limitation. As such, this detailed description of various embodiments should not be construed to limit the scope or breadth of the present invention as set forth in the appended claims.

In one implementation, the BD Read Only Memory(BD-ROM) specification provides a number of data structures that needs to be defined on a BD in order for the disc to behave as desired. The BD-ROM specification defines BD Prerecorded and BD Recordable application formats.

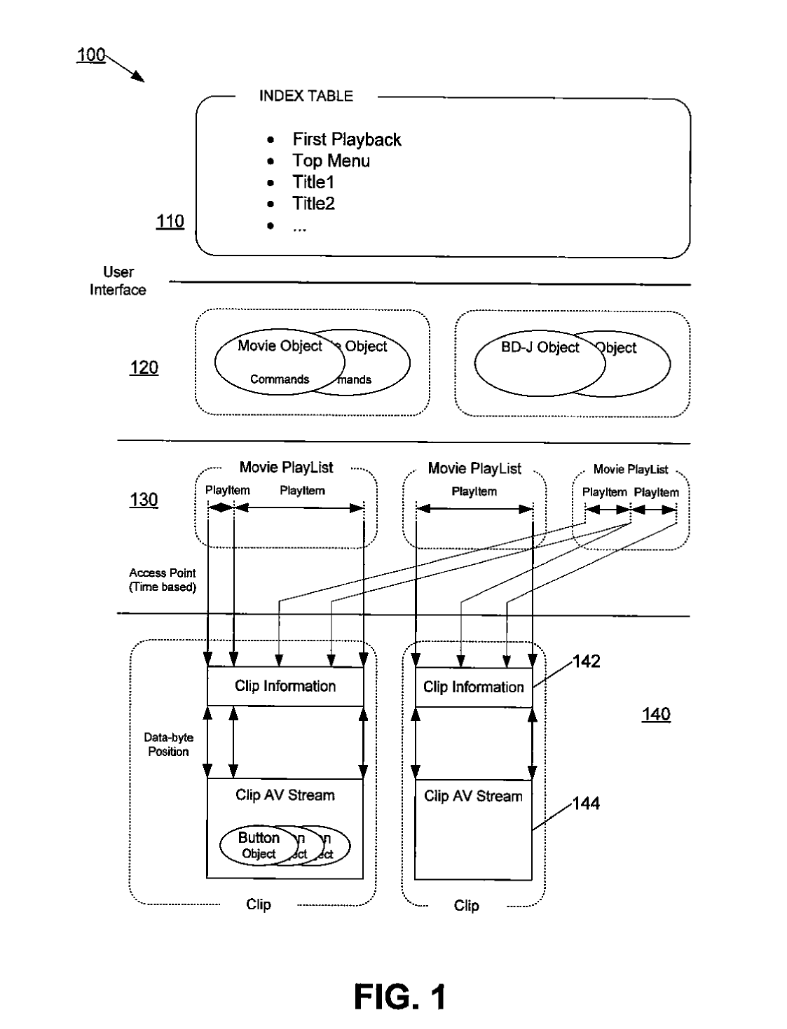

FIG. 1 provides a simplified overview of the BD-ROM data structure 100. BD-ROM has four layers for managing AV stream files as follows: Index Table 110, Movie Object/BD-J Object 120, Playlist 130, and Clip 140.

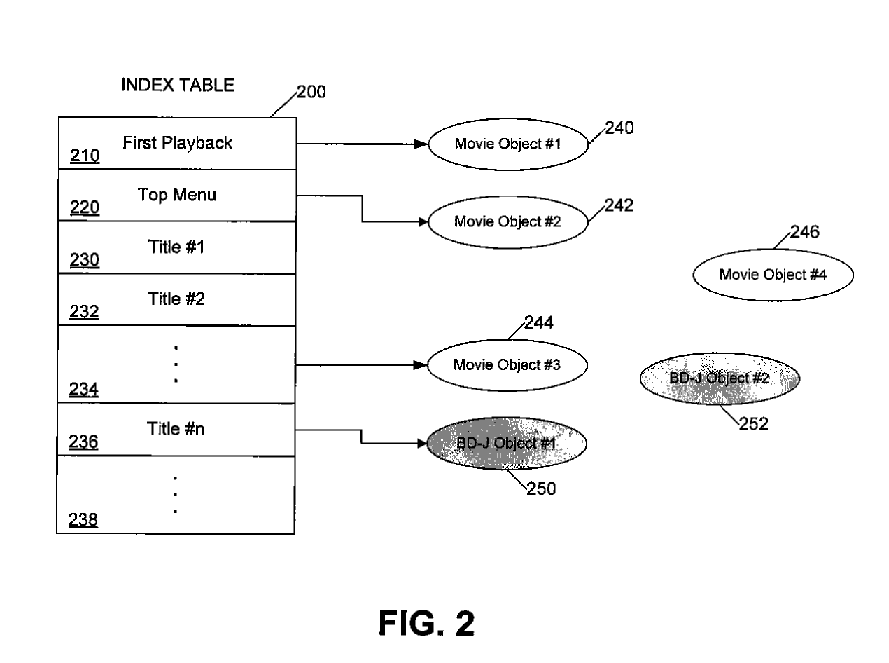

Index Table 200, shown in FIG. 2, is a top-level table structure that defines the Titles of a BD-ROM disc. A Title corresponds to any entry in the Index Table including First Playback 210, Top Menu 220, and Titles 230, 232, 234, 236, 238. First Playback 210 is used by content providers to perform automatic playback. Each Index Table entry links to either a Movie Object 240, 242, 244, 246 or BD-J Object title is to be executed (e.g. whenever the Title Search or Menu Call operation is called).

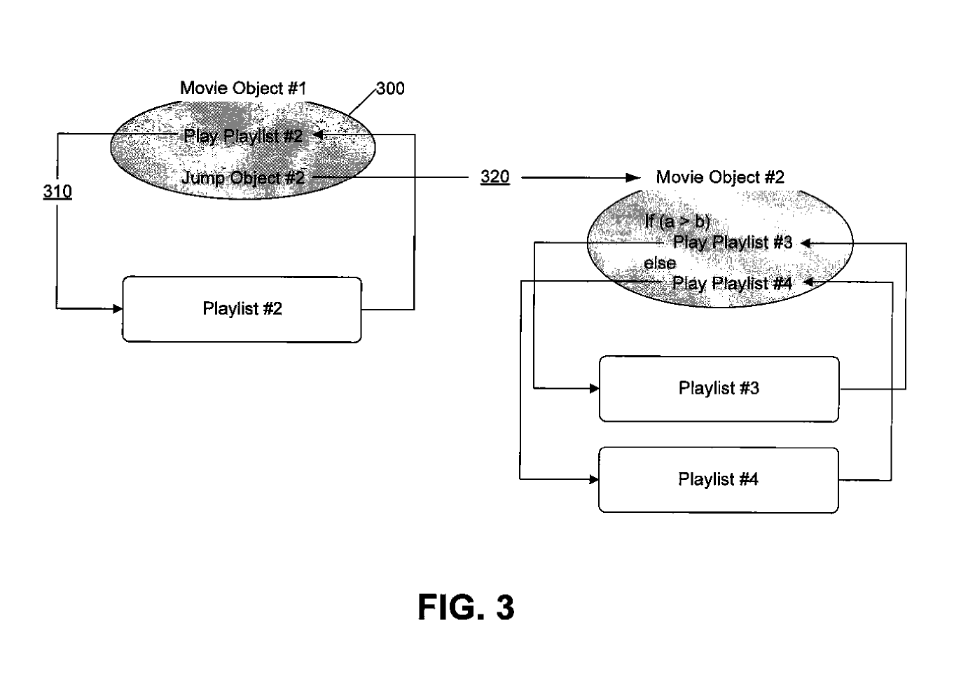

A Movie Object includes an executable lines of codes or navigation commands, which enables dynamic scenario description. Thus, as shown in FIG. 3, navigation commands in a Movie Object (e.g., 300) can launch Playlist playback 310 or another Movie Object 320. This enables the content providers to define a set of Movie Objects for managing playback of Playlists in accordance with a user's interaction and preferences.

When a Title associated with a BD-J Object in the Index Table on disc is selected, the corresponding application is automatically launched and its lifecycle is bound to the Title. A BD-J application is a Java Xlet which is controlled by the BD-ROM player's Application Manager through its Xlet interface. The Xlet interface has four states as follows: loaded, paused, active and destroyed. Once a BD-J application is destroyed, any resources allocated to it, such as memory and AV control, is released.

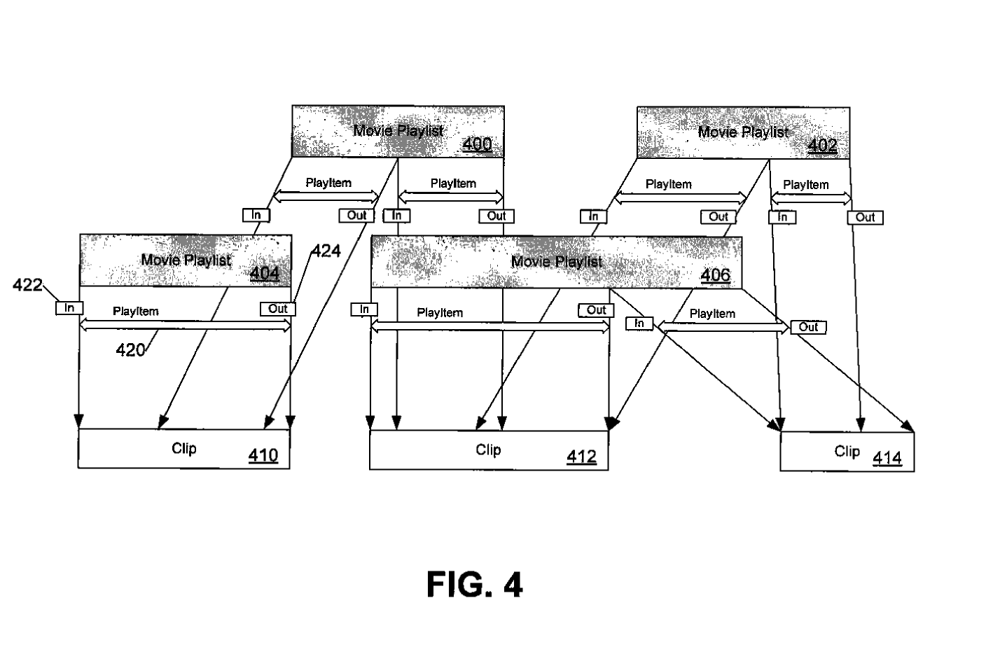

A Playlist (i.e., “Movie Playlist”) 400, 402, 404, 406, illustrated in FIG. 4, is a collection of playing intervals in the Clips 410, 412, 414 that indicates which portion of the Clip to play and when to play the Clip. One such playing interval is called a PlayItem (e.g., 420) and includes an IN-point (e.g., 422) and an OUT-point (e.g., 424), each of which refers to positions on a time axis of the Clip. The IN-point indicates a start point of a playing interval, and the OUT-point indicates an end point of the playing interval.

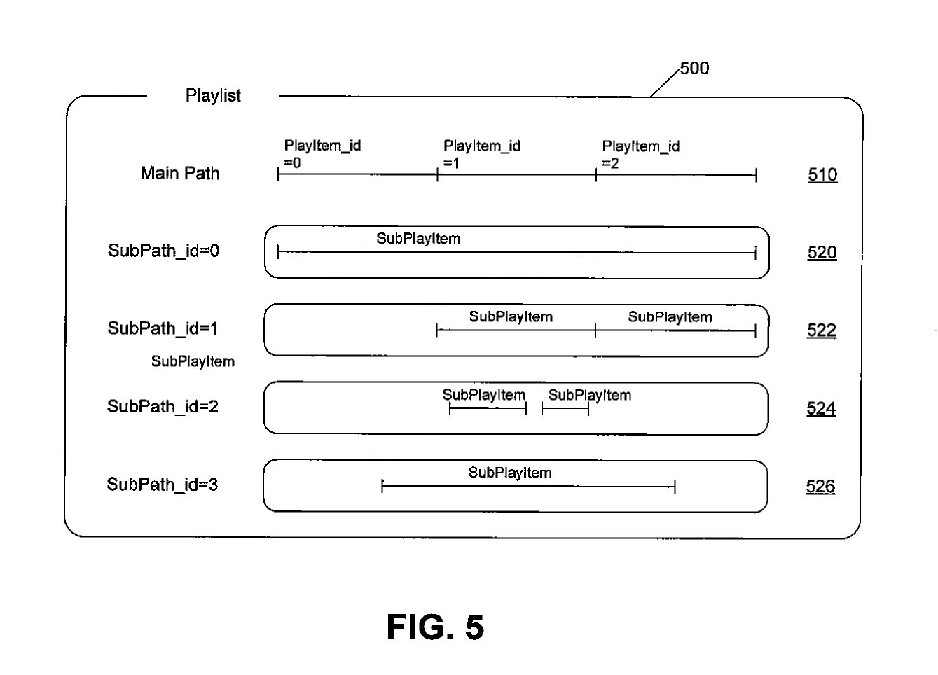

As shown in FIG. 5, a Playlist 500 has one main path 510 that provides a master presentation of the Playlist. The main path 510 may have one or more sub-paths 520, 522, 524, 526 that provide auxiliary presentations associated with the master presentation. The main path 510 includes one or more PlayItems. The sub-path 520, 522, 524, 526 includes one or more SubPlayItems.

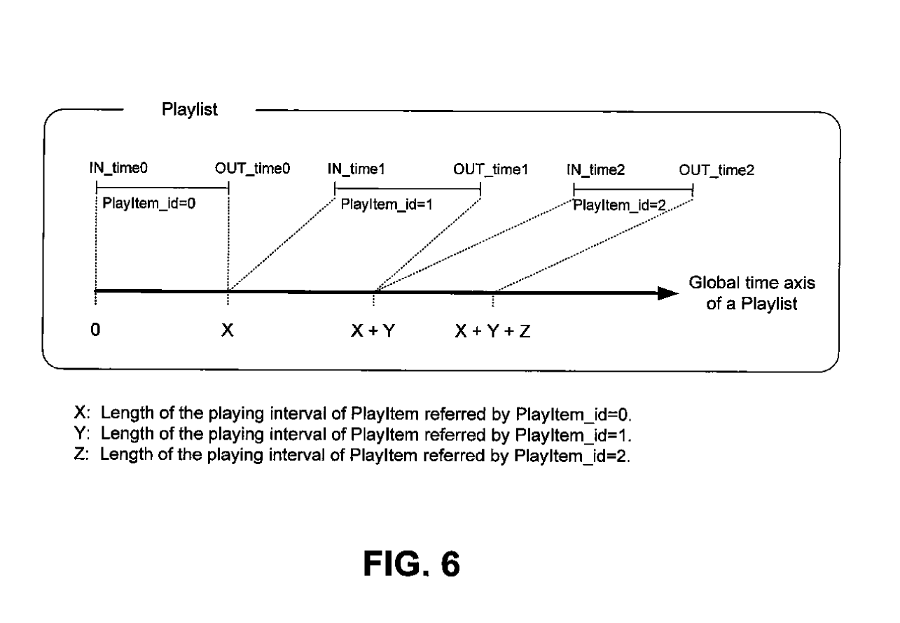

FIG. 6 shows the PlayItem specifying a time based playing interval from the IN-time until the OUT-time. The playing interval refers to a single Clip when the PlayItem does not have a multi-angle structure. The playing interval refers to more than one Clip when the PlayItem has a multi-angle structure.

Referring back to FIG. 1, an AV stream file together with its associated database attributes is considered to be one object. In the context of the BD-ROM data structure, the AV stream file is referred to as a Clip AV stream file 144, and the associated database attribute file is referred to as a Clip Information file 142. An object including the Clip AV stream file 144 and its corresponding Clip information file 142 is referred to as a Clip 140.

The Clip Information file 142 stores the time stamps of the access point into the corresponding AV stream file 144. The BD player reads the Clip Information file 142 to find out the position where it should begin to read the data from the Clip AV stream file 144. Therefore, there is a one-to-one relationship between a Clip AV stream file 144 and a Clip Information file 142.

All media are initially formed as “elementary streams”, which is a way of denoting a file containing just one single type of AV data. For example, video is one elementary stream. If a BD contains two audio streams (e.g., each audio stream representing a particular language), each audio stream is an elementary stream. Each subtitle stream (referred to as ‘Presentation Graphics’ stream or ‘TextSt’ stream in the BD-ROM specification) is also a separate elementary stream. Therefore, the BD authoring system (BDAS) reads a number of elementary stream files and merges the files together to form data written onto a BD.

An access unit is a segment of an elementary stream (ES) that represents a small logical unit of data. Thus, an access unit is often used directly without reference to other parts of the elementary stream. For example, a single frame of video may be an access unit, or a section of an AC3 file representing a particular period of time, when decoded. Accordingly, access units are important primarily because they allow random access to any part of the AV stream (e.g., a user of a BD player can skip to any chapter and begin playback, or instruct the player to begin playback at a certain time into the movie).

However, access units can be very large (e.g., perhaps hundreds of kilobytes for a video frame). Thus, elementary streams must be further sub-divided (i.e., packetized) into small chunks, each of which fits into a single sector on the BD. The packetization process typically involves breaking up the elementary stream into a series of fixed-size chunks of bytes, where each of these chunks is known as a “packet” and will fit within a single sector on the disc. An elementary stream that has been divided into packets is known as a Packetized Elementary Stream (PES). For a structure compliant with the BD-ROM specification, the Clip AV stream file stores a PES referred to as an MPEG-2 Transport Stream (MPEG-2 TS).

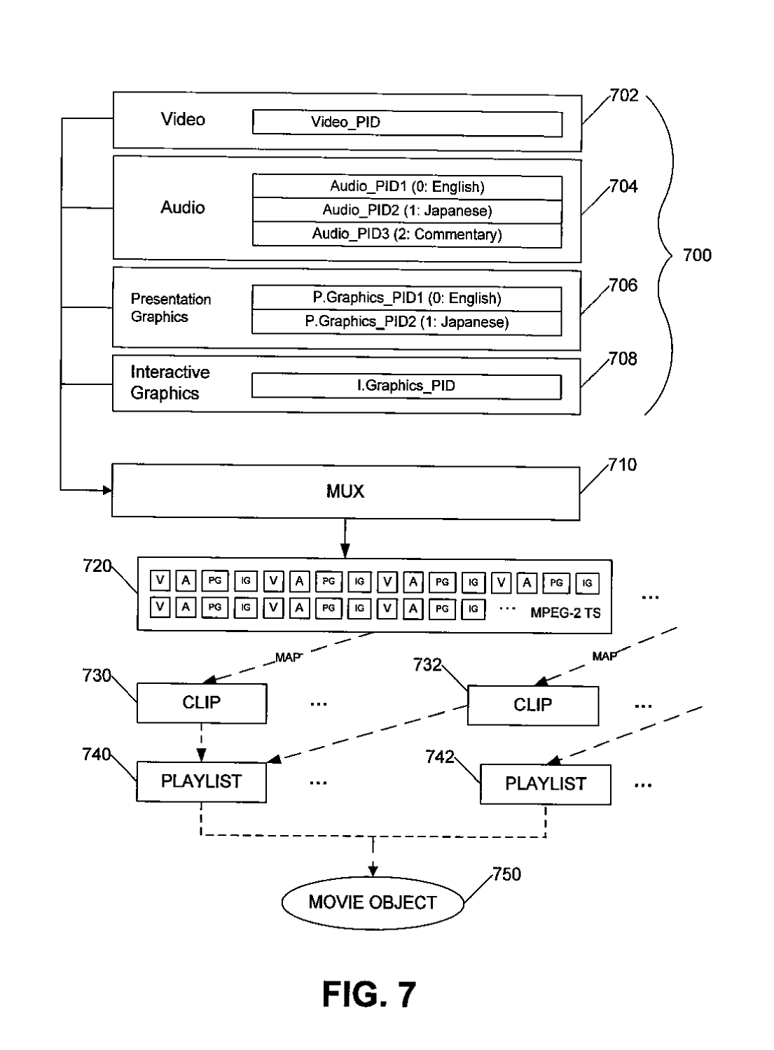

FIG. 7 shows an example process of merging elementary stream data 700 into an MPEG-2 TS file 720 and generating basic playable entities such as Playlist 740, 742, Clip 730, 732, and Movie Object 750. The playable entities can also include PlayItems.

In the illustrated implementation of FIG. 7, the elementary stream data 700 includes a video elementary stream 702, an audio elementary stream 704, a presentation graphics elementary stream 706, and an interactive graphics elementary stream 708. The elementary stream data are received and merged by a multiplexer 710 to generate a packetized stream file such as the MPEG-2 TS file 720. Playable Content, representing playable entities, is then generated. The playable entities include, among others, Playlists 740, 742, Clips 730, 732, and Movie Objects 750, and provide information describing the MPEG-2 TS file 720.

In one implementation, a Clip 730, 732 (similar to a Clip Information File 142 in FIG. 1) is generated by mapping the MPEG-2 TS file 720. For example, Clip 730 includes a description of the MPEG-2 TS file 720 including a description of: how many packets of video, audio, and other media data; what formats; how many channels; and other characteristics of the media data in the MPEG-2 TS file 720. Furthermore, as described above, each Playlist 740, 742 is generated as a collection of playing intervals in Clips, while the Movie Object 750 is generated with executable codes or commands that manage Playlists 740, 742.

Given the BD-ROM data structure as described above, a BDAS provides an environment to: receive the elementary stream data of different formats (e.g., video, audio, subtitle, etc.); assemble these data; define how the data will interact with each other (e.g., which data plays first, what happens when a particular button is pressed, etc.); and generate an output image to the BD. The BDAS provides to the user a methodology to simplify the complex structures and their interlinking to make the authoring process easier.

The methodology includes abstractions that offer the functionality for a user to switch the view based on the requirements and level of expertise. This switching of the view either hides or exposes different levels of the underlying details of the data structures created by the user, directly or indirectly. At the top level, only a few of the high level structures are presented, whereas at the lowest level many simpler interconnected structures are exposed. This methodology also provides a mechanism to author projects independent of the underlying format to which the final project output needs to comply.

Abstractions represent objects that are presentation oriented. For example, following objects are abstractions that can be used in BD authoring: playable contents, segments, scripts, clips, streams, events, interactive objects, and effects. Other abstractions can be used in BD authoring.

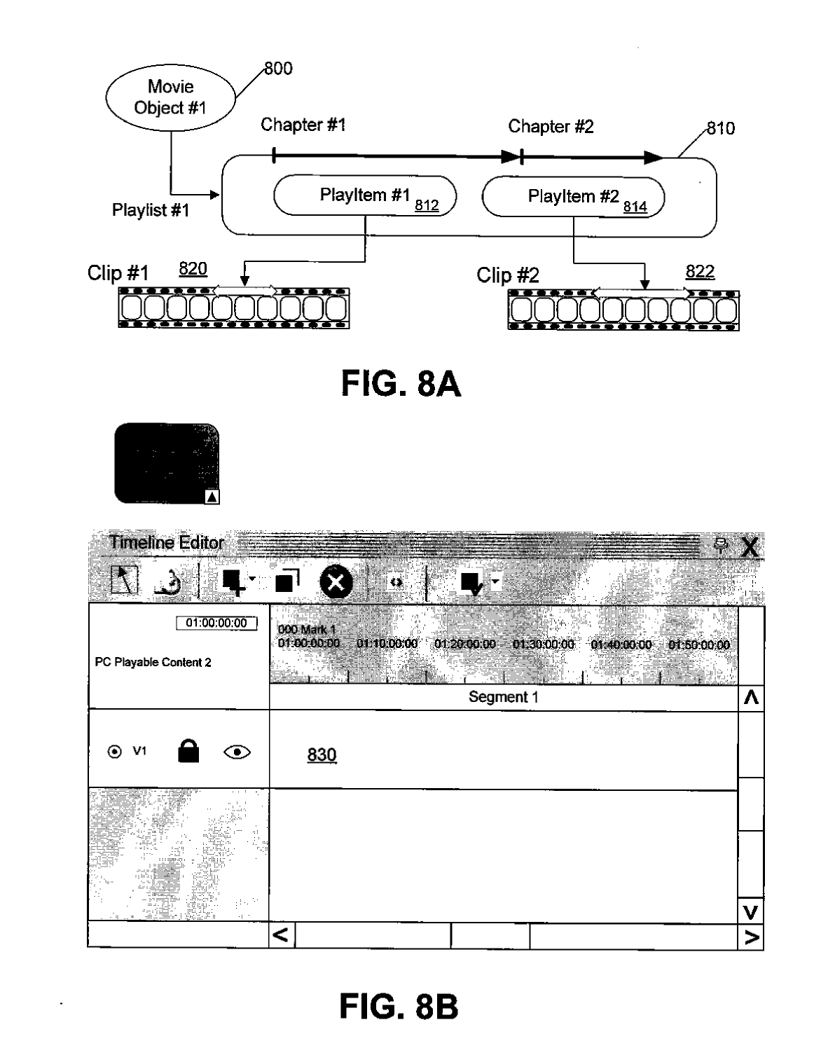

In one implementation, playable contents include playable content, a title, a menu, virtual playable content, multi-story playable content, multi-angle playable content, a single segment time-based slideshow, a multi-segment time-based slideshow, and a browsable slideshow. The playable content is an abstraction that represents the basic playable entity, and includes the data structure necessary for playback on a BD player. For example, as shown in FIG. 8A, playable content represents a Movie Object 800, a Playlist 810, PlayItems 812, 814, and Clips 820, 822. Further, as shown in FIG. 8B, playable content includes a video stream 830 by default.

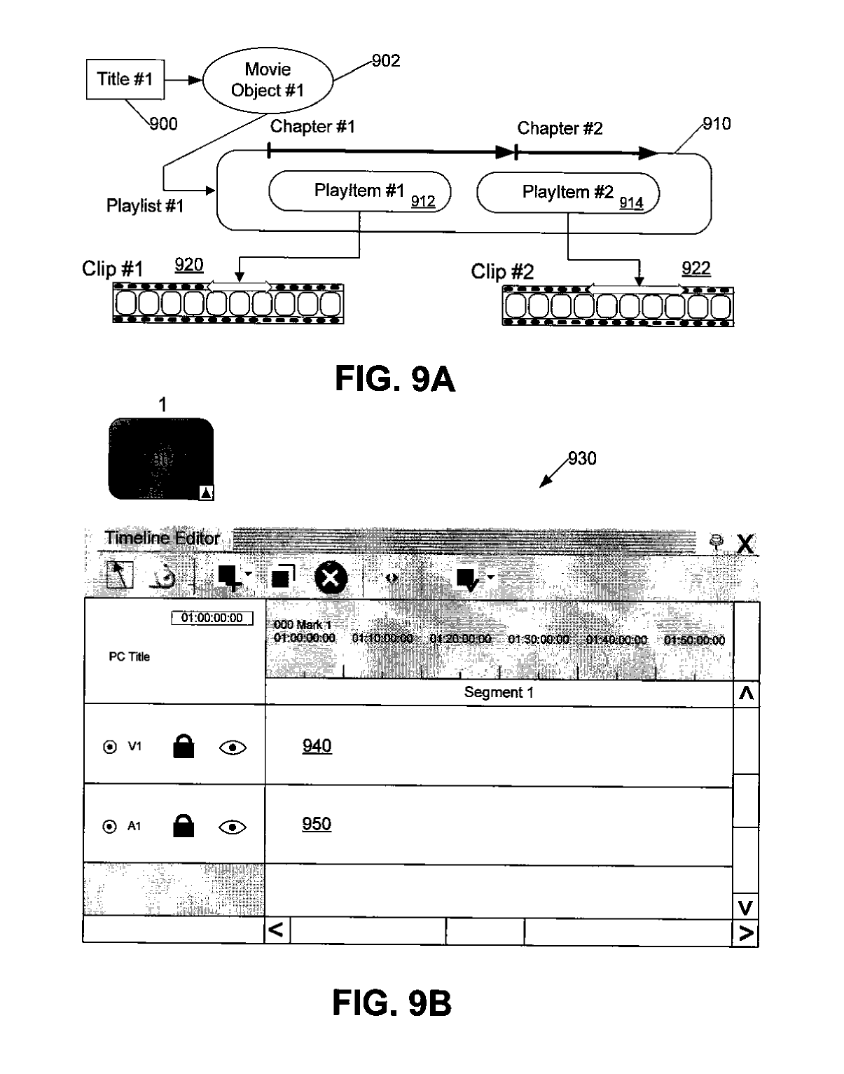

When Playable Content is assigned an entry in the Index Table, it becomes a Title. As shown in FIG. 9A, a Title is generated directly using a Title object 900. Again, Playable Content also represents a Movie Object 902, a Playlist 910, PlayItems 912, 914, and Clips 920, 922. Further, as shown in FIG. 9B, a Title includes a video stream 940 and an audio stream 950 by default.

In the illustrated implementation of FIG. 9B, a user can drag and drop the elementary streams of media data (e.g., the video stream 940 and the audio stream 950) into the Playable Content structure of the BDAS 930, and instruct it to multiplex the streams of media data. In response, the Playable Content structure of the BDAS 930 multiplexes the elementary streams of media data, and automatically generates the basic playable entities 902, 910, 912, 914, 920, 922 needed for authoring a BD. Thus, the user can then adjust items such as timeline in the Playable Content structure of the BDAS 930 to adjust the parameters of the generated playable entities 902, 910, 912, 914, 920, 922.

For example, in one implementation, when the elementary streams of media data are received, the Playable Content structure of the BDAS 930 determines the characteristics of the media data such as length and format. Then, when the multiplex instruction is received, the Playable Content structure 930 generates an MPEG-2 TS file and a corresponding Clip (e.g., 920 or 922). The Playable Content structure 930 also generates PlayItems (e.g., 912 or 914), a playlist (e.g., 910), and a move object (e.g., 902).

As mentioned above, another abstract structure that the BDAS exposes is Virtual Playable Content, which allows reuse of Clips belonging to other Playable Contents. For example, if there are three ‘Deleted Scenes’ in a project that are Playable Contents configured to be played individually, then Virtual Playable Content can be used to generate a Playlist of the three ‘Deleted Scenes’ to play all three scenes in a ‘Play All’ scenario. In another example of Virtual Playable Content, if a part of a large Playable Content needs to be played independently, then that part can be put into Virtual Playable Content that includes a trimmed version of the Playable Content.

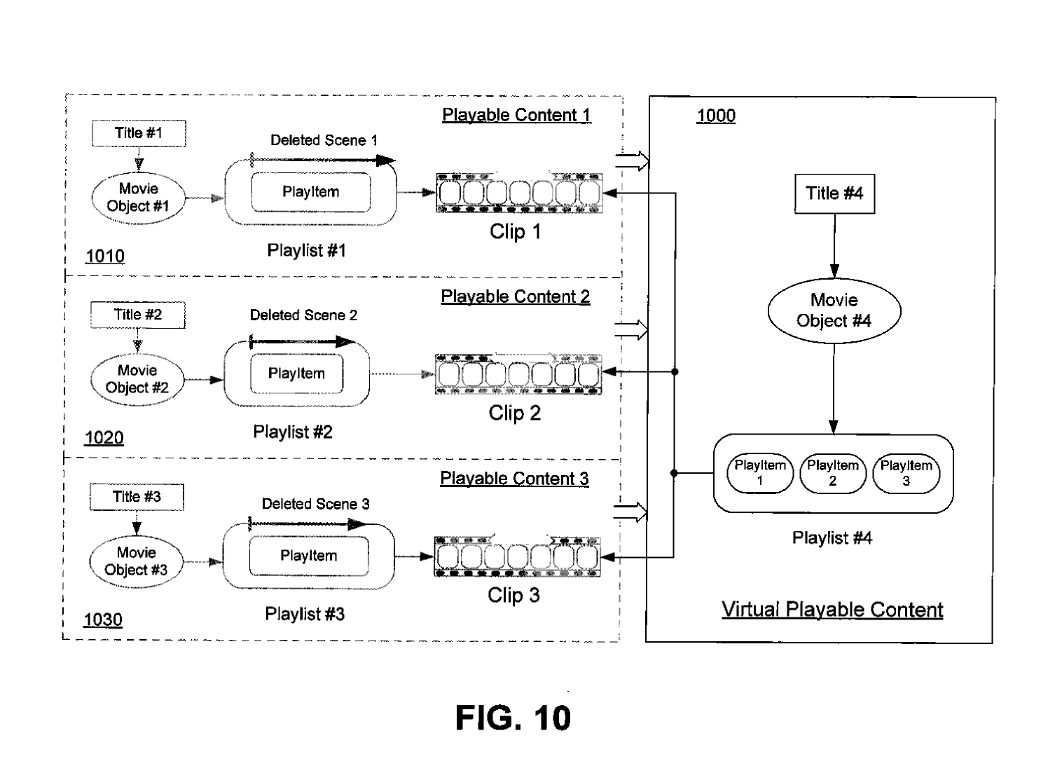

Referring to FIG. 10, assuming Clip 1 through Clip 3 represent the three ‘Deleted Scenes’, Playlist #1 in Playable Content 1010 includes a PlayItem that plays Clip 1, Playlist #2 in Playable Content 1020 includes a PlayItem that plays Clip 2, and Playlist #3 in Playable Content 1130 includes a PlayItem that plays Clip 3. If all three deleted scenes are to be played in a ‘Play All’ scenario, then Virtual Playable Content 1000 can be generated with Playlist #4 configured to play all three scenes: Clip 1, Clip 2, and Clip 3. Thus, the Playable Content structure of the BDAS generates Virtual Playable Content 1000 by assembling basic playable entities of Playable Contents 1010, 1020, 1030.

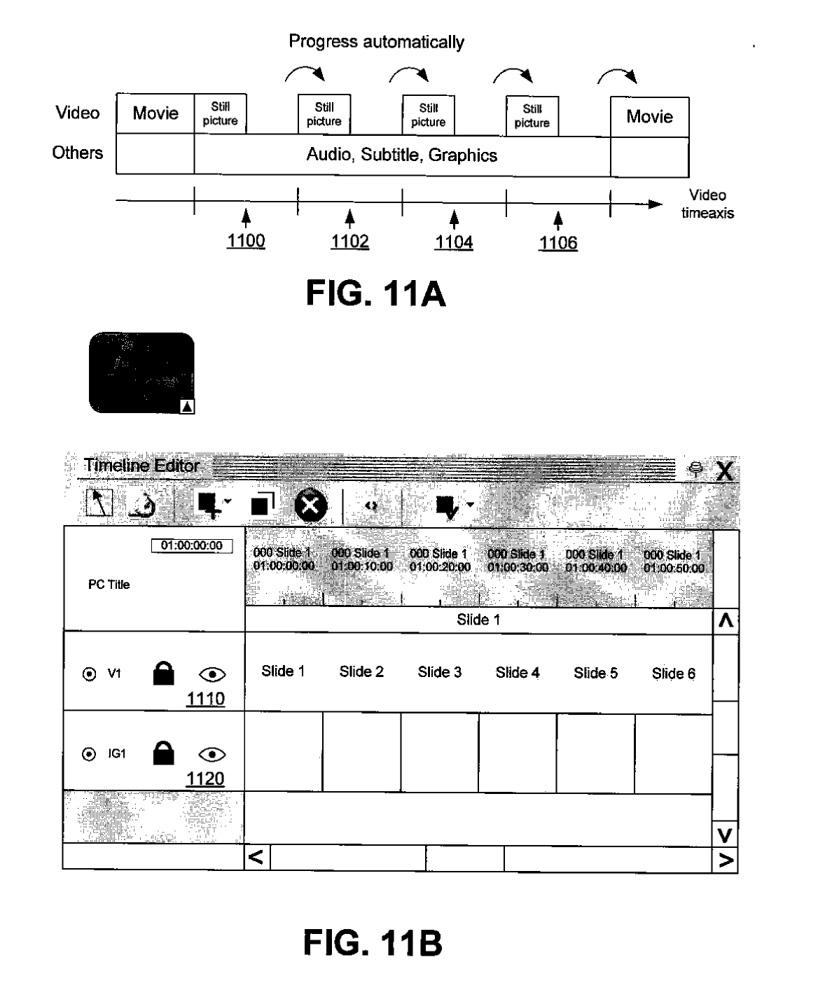

A single segment time-based slideshow (see FIG. 11) is an abstraction that represents the Time-based Slideshow object with a single PlayItem. This type of slideshow allows the authoring of synchronized audio with still frame pictures. As shown in FIG. 11A, there is no interruption at slide boundaries (e.g., 1100, 1102, 1104). As shown in FIG. 11B, the Single Segment Time-based Slideshow objects are generated with video 1110 and interactive graphics 1120 streams by default. Entry Marks (one at the beginning of each slide) are also created by default to ease the authoring burden on the user.

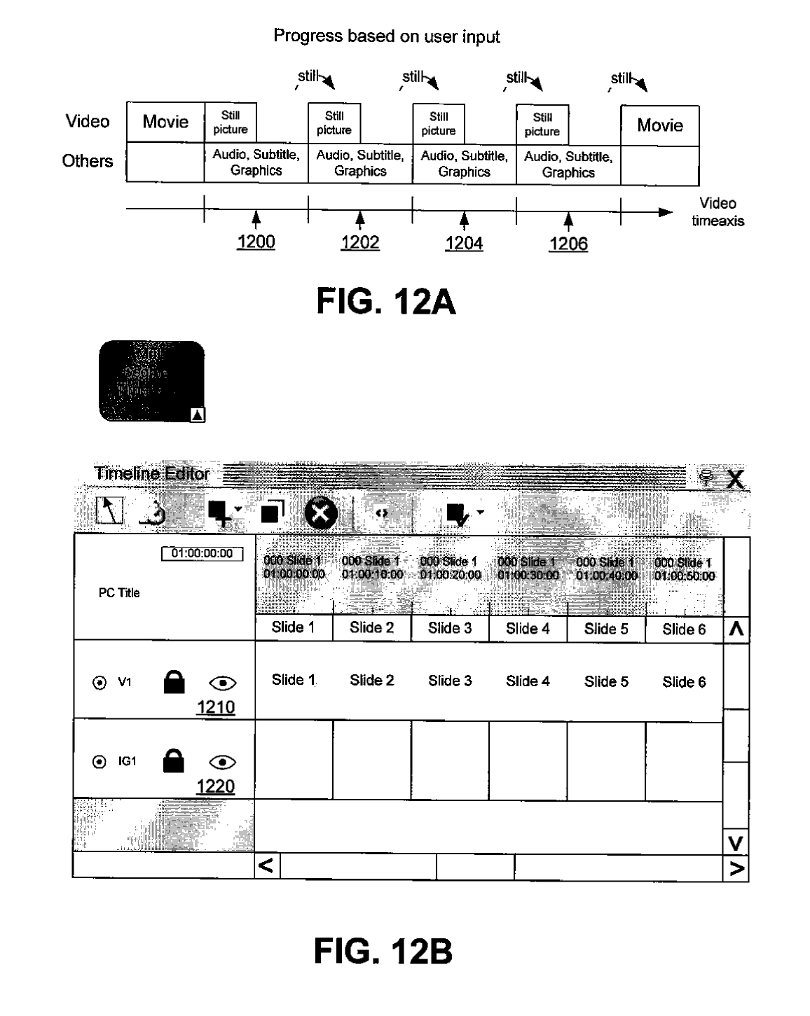

A multi-segment time-based slideshow (see FIG. 12) is an abstraction that represents the Time-based Slideshow object with multiple PlayItems. This type of slideshow presentation allows the authoring of still frame pictures with non-continuous audio across slides. As shown in FIG. 12A, there is ‘still time’ at the end of each slide (e.g., 1200, 1202, 1204, 1206). As shown in FIG. 12B, the Multi-Segment Time-based Slideshow objects are generated with video 1210 and interactive graphics 1220 streams by default. Entry Marks (one at the beginning of each slide) are also created by default to ease the authoring burden on the user.

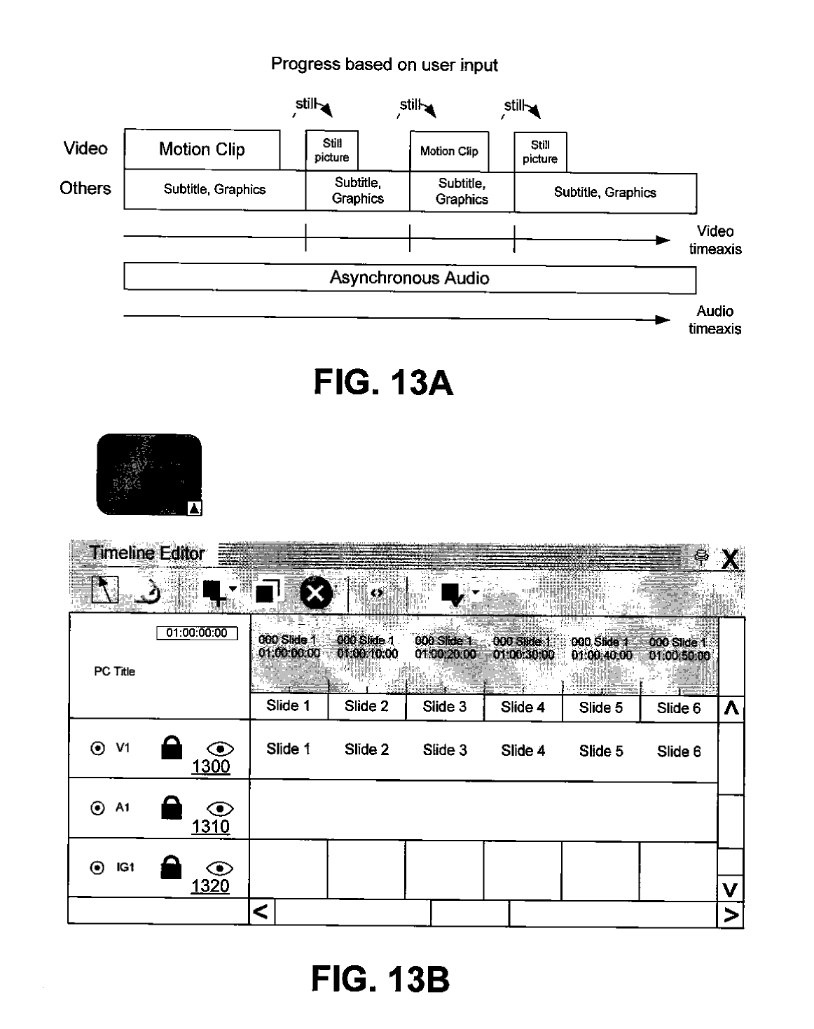

A browsable slideshow illustrated in FIG. 13 is an abstraction that represents the Browsable Slideshow object. This type of slideshow presentation allows the authoring of still frame pictures or short video slides with asynchronous audio across slides. Audio does not get interrupted when slides are navigated by the user. As shown in FIG. 13A, there is ‘still time’ at the end of each slide. As shown in FIG. 13B, the Browsable Slideshow objects are generated with video 1300, asynchronous audio 1310, and interactive graphics 1320 streams by default. Entry Marks (one at the beginning of each slide) are also created by default to ease the authoring burden on the user.

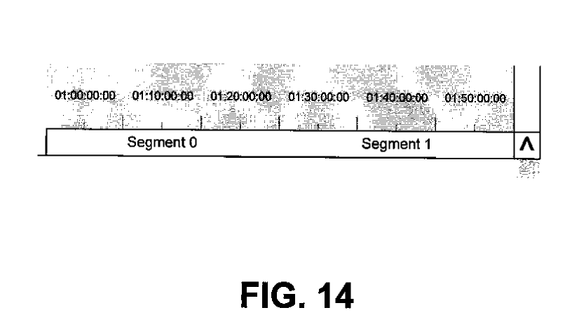

A segment illustrated in FIG. 14 is an abstraction that represents a PlayItem object in the BD-ROM format. In the playable content abstraction, multiple segments typically indicate multiple PlayItems and possibly multiple clips. In the slideshow abstraction, segments are used to indicate PlayItem properties such as “still time”.

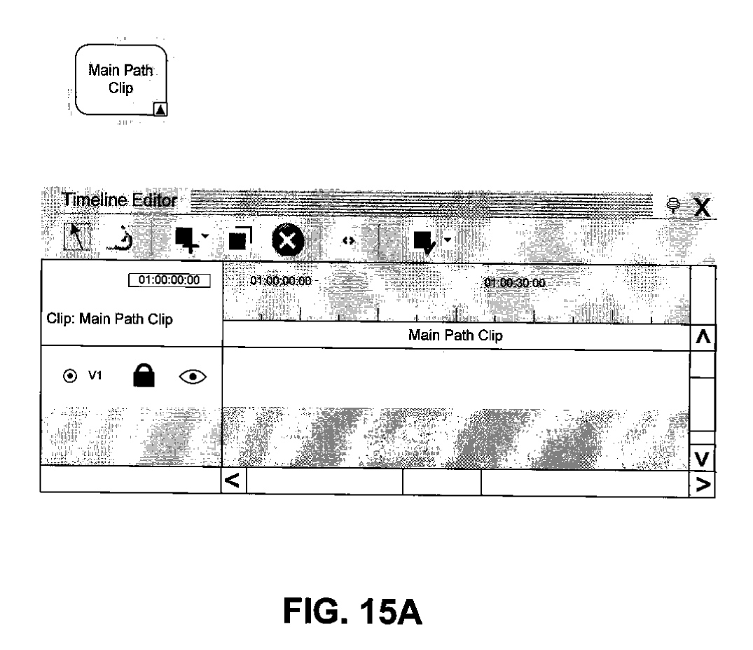

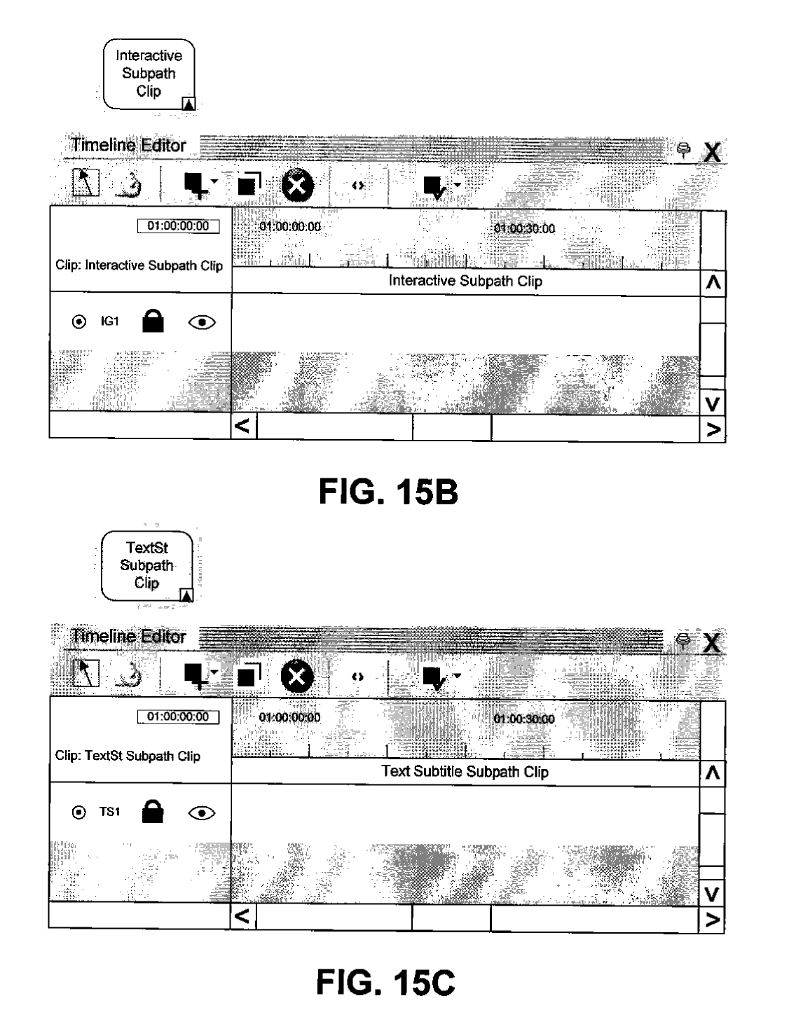

Clips illustrated in FIG. 15 are abstractions that represent ‘Clip’ objects in the BD-ROM format. Clip objects map directly to the Clip AV Stream file and the Clip Information file. FIG. 15A illustrates one example of a Main Path Clip; FIG. 15B illustrates one example of an Interactive Subpath Clip; and FIG. 15C illustrates one example of a Text Subtitle Subpath Clip. In one implementation, these Clip objects are used to place AV content on the BD for use in virtual playable contents or to stay dormant until unlocked by downloaded enhancements.

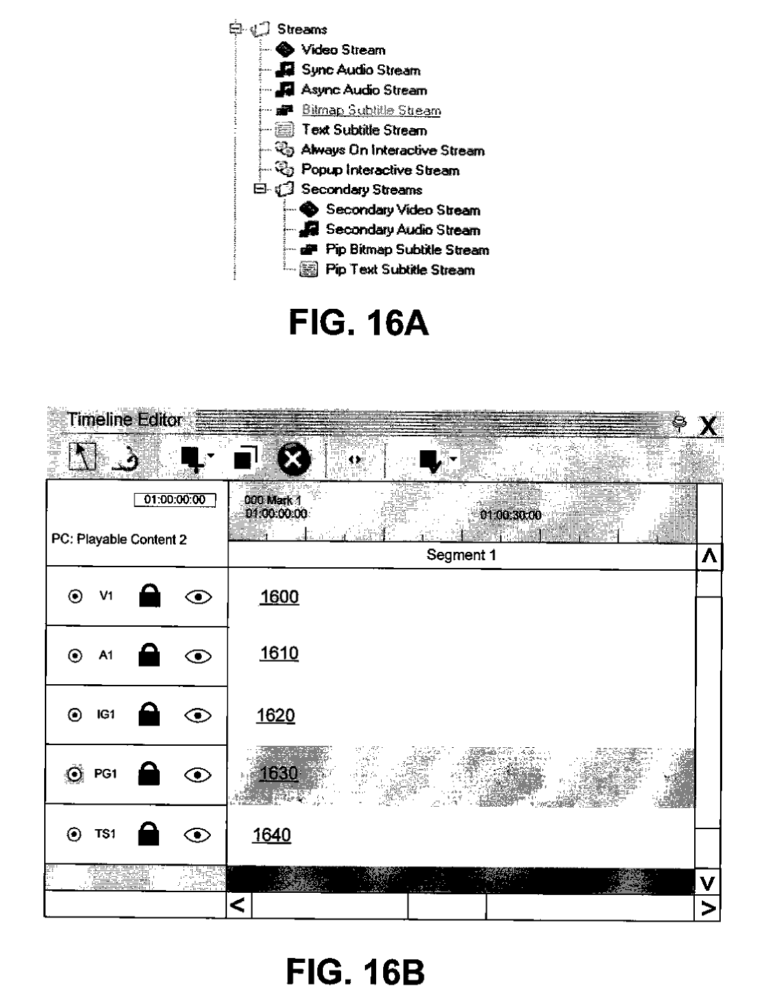

Streams are included in many types of playable contents. For example, FIG. 16A shows a directory of streams including following sub-directories: a Video Stream, a Synchronous Audio Stream, an Asynchronous Audio Stream, a Bitmap Subtitle Stream, a Text Subtitle Stream, an Always On Interactive Stream, a Popup Interactive Stream, and Secondary Streams. FIG. 16B illustrates playable contents including following streams: a Video Stream 1600, an Audio Stream 1610, an Interactive Graphics Stream 1620, a Presentation Graphics Stream 1630, and a Text Subtitle Stream 1640. The BD-ROM specification specifies the possible combinations allowed in the BD authoring tool.

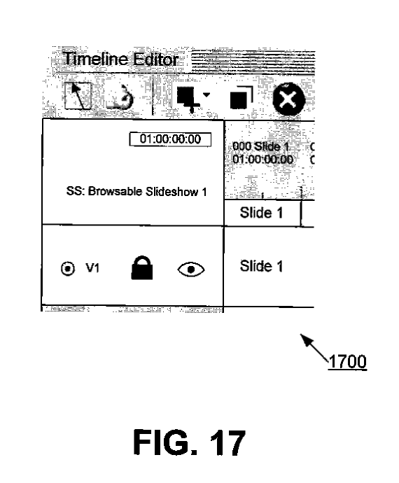

A Slide object 1700 illustrated in FIG. 17 is an abstraction that represents the video presentation unit in slideshows. Slides may be added to video streams in Timebased and Browsable Slideshow playable contents. Still mode and Still time may be set for a Slide. Video files dropped into the slides will be automatically concatenated by the BD authoring tools. Interactive Events are automatically generated at the time of slide creation.

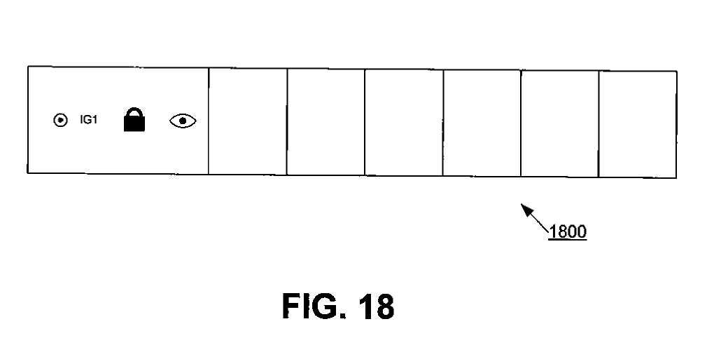

Menu Events 1800 illustrated in FIG. 18 are abstractions that represent an Interactive Composition Segment. All interactive elements are included in a Menu Event. The objects allowed immediately inside a Menu Event are Page Layer Compositions.

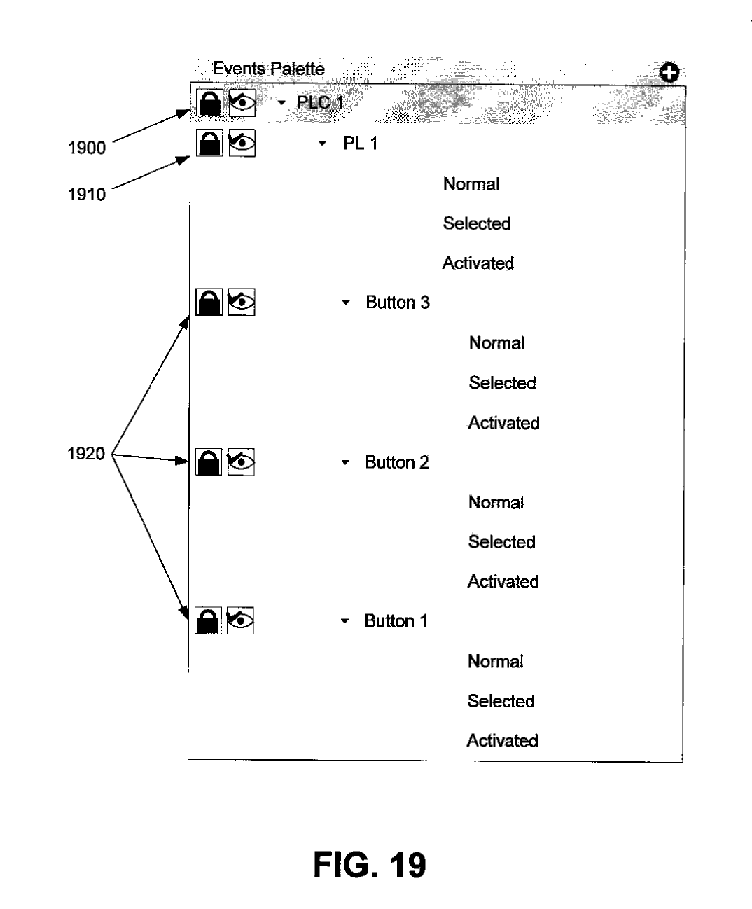

FIG. 19 illustrates an example of objects and elements including a Page Layer Composition (PLC) 1900, a Page Layer (PL) 1910, and Buttons 1920. The Page Layer Composition (PLC) 1900 is a collection of visual objects to be shown to the user at any one time. A PLC can include many Page Layers and represent a Page in the BD-ROM specification. The Page Layer (PL) 1910 is a logical grouping of Buttons 1920. All Page Layers in a PLC are visible together. Page Layers are used to group buttons when they are needed on multiple pages since they can be copy-pasted from one PLC to another. A Button is a primitive interactive element that represents the button object with Normal, Select, and Activate states.

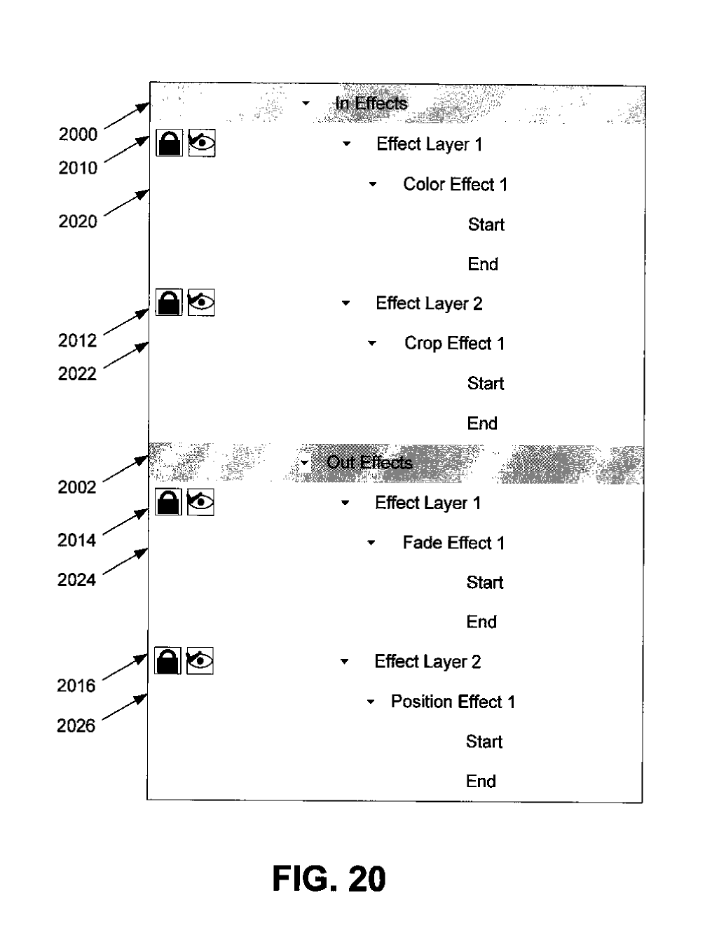

As shown above, in the Events Palette, each PLC can have an In Effect and an Out Effect. FIG. 20 illustrates an example of effects including In Effect 2000 and Out Effect 2002. An “In Effect” is executed when the PLC is made active. If one exists, the In Effect is executed before the PLC is presented. An “Out Effect” is executed when the PLC is made inactive. After the PLC is removed from the display, the Out Effect is executed if an Effect Off flag is not set when a SetButtonPage command is executed.

Each of the In Effect 2000 and the Out Effect 2002 is composed of Effect Layers 2010, 2012, 2014, 2016. In the illustrated implementation, each Effect Layer represents one of the two objects that can be animated during an “Effect”, which is the base object that represents the animation of the Effect Layer. In one implementation, there are five Effects, which include color effect 2020, crop effect 2022, fade effect 2024, position effect 2026, and wipe effect (not shown).

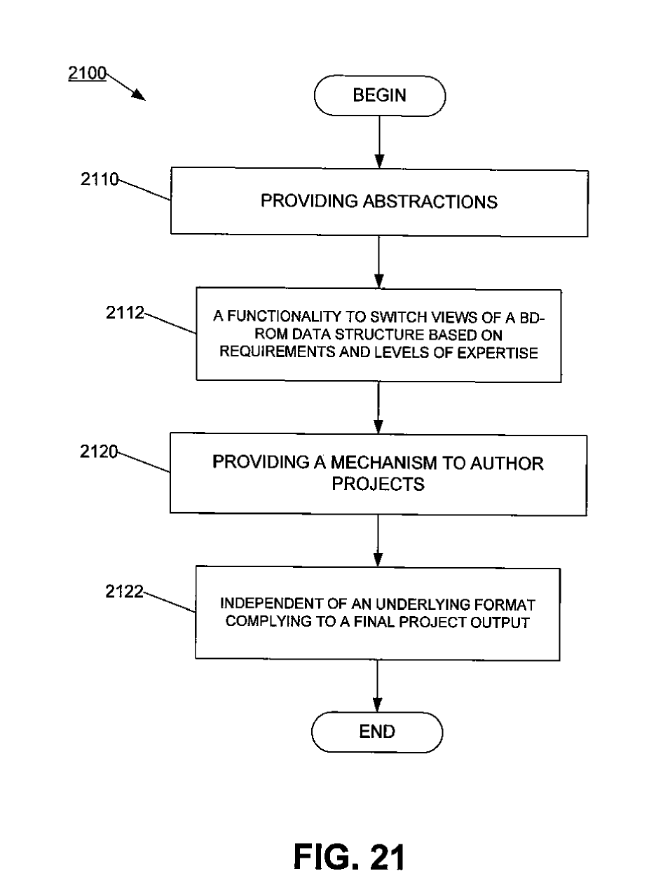

FIG. 21 is a flowchart 2100 illustrating a method for authoring a Blu-ray Disc. The BD authoring method provides to the user a methodology to simplify the complex structures and their interlinking to make the authoring process easier. For example, in the illustrated implementation of FIG. 21, the methodology provides abstractions, at box 2110, that offer the functionality for a user to switch the views of a BD-ROM data structure based on the requirements and level of expertise (at box 2112). This switching of the view either hides or exposes different levels of the underlying details of the data structures created by the user. At the top level, only a few of the high level structures are presented, whereas at the lowest level many simpler interconnected structures are exposed. At box 2120, the BD authoring method further provides a mechanism to author projects, which are independent of the underlying format to which the final project output needs to comply (at box 2122).

As described above, abstractions represent objects that are presentation oriented. For example, following objects are abstractions that can be used in BD authoring: playable contents, segments, scripts, clips, streams, events, interactive objects, and effects. Other abstractions can be used in BD authoring.

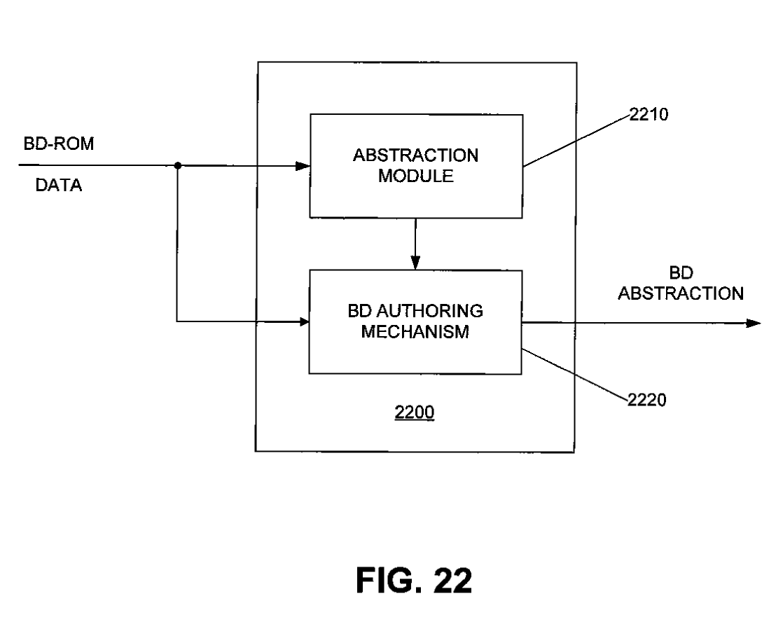

FIG. 22 is a block diagram of a BD authoring system 2200, which receives BD-ROM data as an input and outputs an abstraction of the BD-ROM data. The BD authoring system 2200 includes an abstraction module 2210 and a BD authoring mechanism 2220. The abstraction module 2210 receives BD-ROM data and provides abstractions that offer the functionality for a user to switch the views of a BD-ROM data structure based on the requirements and level of expertise. As described above, the switching of the view either hides or exposes different levels of the underlying details of the data structures created by the user. The BD authoring mechanism 2220 receives BD-ROM data and/or generated abstractions to author projects, which are independent of the underlying format to which the final project output needs to comply. Therefore, the output of the SD authoring system 2200 includes abstractions such as playable contents, segments, scripts, clips, streams, events, interactive objects, and effects.

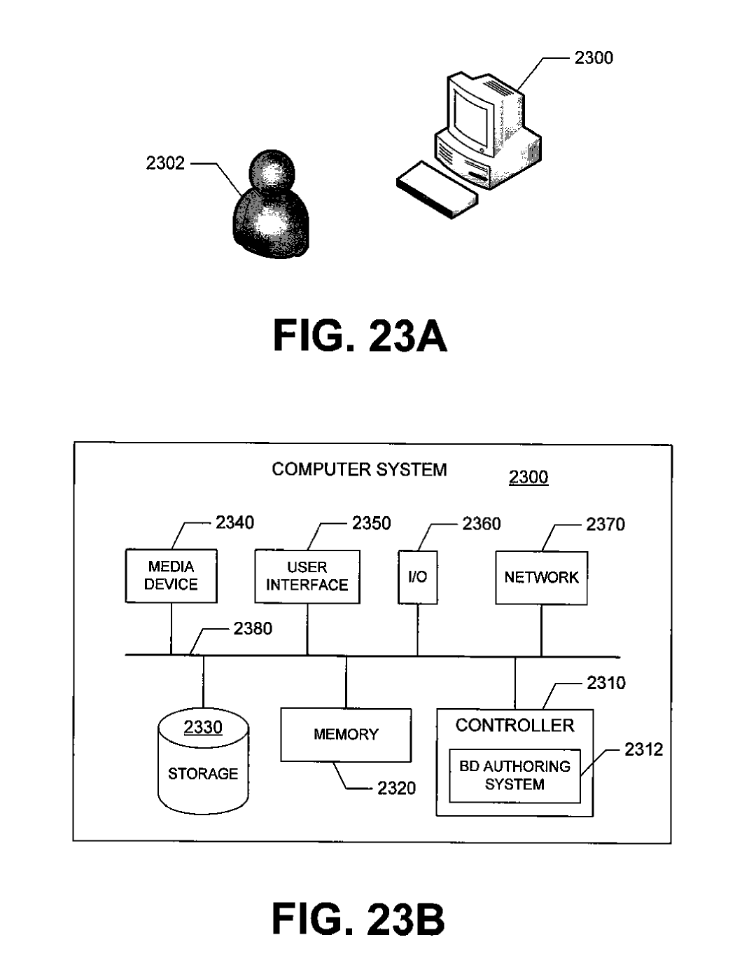

FIG. 23A shows a representation of a computer system 2300 and a user 2302. The user 2302 can use the computer system 2300 to author a Blu-ray disc. The computer system 2300 stores and executes a BD authoring system 2312, which receives BD-ROM data as an input and outputs an abstraction of the BD-ROM data. In one example, the output of the BD authoring system 2312 includes abstractions such as playable contents, segments, scripts, clips, streams, events, interactive objects, and effects.

FIG. 23B shows a block diagram of one implementation of the computer system 2300 in FIG. 23A, including the BD authoring system 2312. The computer system 2300 includes a controller 2310, a memory 2320, storage 2330, a media device 2340, a participant interface 2350, an input/output (I/O) interface 2360, and a network interface 2370. These components are interconnected by a common bus 2380. Alternatively, different connection configurations can be used, such as a star pattern with the controller at the center.

The controller 2310 is a programmable processor and controls the operation of the computer system 2300 and its components. The controller 2310 loads instructions from the memory 2320 or an embedded controller memory (not shown) and executes these instructions to control the system. In its execution, the controller 2310 provides the BD authoring system 2312 as a software system. Alternatively, this service can be implemented as separate components in the controller 2310 or the computer system 2300.

Memory 2320 stores data temporarily for use by the other components of the computer system 2300. In one implementation, memory 2320 is implemented as RAM. In one implementation, memory 2320 also includes long-term or permanent memory, such as flash memory and/or ROM.

Storage 2330 stores data temporarily or long term for use by other components of the computer system 2300, such as for storing BD data used by the BD authoring system 2312. In one implementation, storage 2330 is a hard disk drive.

The media device 2340 receives removable media and reads and/or writes data to the inserted media. In one implementation, the media device 2340 is an optical disc drive.

The user interface 2350 includes components for accepting user input from the user of the computer system 2300 and presenting information to the user. In one implementation, the user interface 2350 includes a keyboard, a mouse, audio speakers, and a display. The controller 2310 uses input from the user to adjust the operation of the computer system 2300.

The I/O interface 2360 includes one or more I/O ports to connect to corresponding I/O devices, such as external storage or supplemental devices (e.g., a printer or a PDA). In one implementation, the ports of the I/O interface 2360 include ports such as: USB ports, PCMCIA ports, serial ports, and/or parallel ports. In another implementation, the I/O interface 2360 includes a wireless interface for communication with external devices wirelessly.

The network interface 2370 includes a wired and/or wireless network connection, such as an RJ-45 or “Wi-Fi” interface (802.11) supporting an Ethernet connection.

The computer system 2300 includes additional hardware and software typical of computer systems (e.g., power, cooling, operating system), though these components are not specifically shown in FIG. 23B for simplicity. In other implementations, different configurations of the computer system can be used (e.g., different bus or storage configurations or a multi-processor configuration).

Various illustrative embodiments of the present invention have been described. However, one of ordinary skill in the art will recognize that additional embodiments are also possible and within the scope of the present invention. For example, although the disk authoring system has been described exclusively in terms of the BD format, the system can be used to author disks in formats other than the BD format (e.g., the HD-DVD format).

Accordingly, the present invention is not limited to only those embodiments described above.

What is claimed is:

1. A method for authoring a Blu-ray Disc, the method comprising:
providing abstractions that offer a functionality for a user to switch views of a BD-ROM data structure based on requirements and levels of expertise of the user; and
providing a mechanism to author projects independent of an underlying format compliant to a final project output format.

2. The method of claim 1, wherein switching of views of the BD-ROM data structure includes
hiding different levels of underlying details of the ED-ROM data structure created by the user.

3. The method of claim 1, wherein switching of views of the BD-ROM data structure includes
exposing different levels of underlying details of the BD-ROM data structure created by the user.

4. The method of claim 3, wherein exposing different levels of underlying details includes:
presenting only a few of high level BD-ROM data structures; and
exposing many simpler interconnected low level BD-ROM data structures.

5. The method of claim 1, wherein said abstractions represent objects that are presentation oriented.

6. The method of claim 5, wherein objects include
playable contents, segments, scripts, clips, streams, events, interactive objects, and effects.

7. The method of claim 6, wherein playable contents include
playable content, a title, a menu, virtual playable content, multi-story playable content, multi-angle playable content, a single segment time-based slideshow, a multi-segment time-based slideshow, and a browsable slideshow.

8. The method of claim 7, further comprising
abstracting the playable content that represents the basic playable entity including an Index Table entry, a Movie Object, a Playlist, PlayItems, and Clips.

9. The method of claim 7, further comprising
abstracting the playable content that represents BD Java code, a Playlist, PlayItems, and Clips.

10. The method of claim 7, further comprising
abstracting the virtual playable content that allows reuse of clips belonging to other playable contents.

11. The method of claim 6, wherein the interactive objects include
a Page Layer Composition (PLC), a Page Layer (PL), and Buttons.

12. The method of claim 6, wherein the interactive objects include
effects.

13. The method of claim 6, wherein the interactive objects include
transistions.

14. A Blu-ray Disc authoring system, comprising:
an abstraction module configured to receive BD-ROM data and provide abstractions that offer a functionality for a user to switch views of a BD-ROM data structure based on requirements and levels of expertise of the user; and
a BD authoring mechanism configured to author projects independent of an underlying format compliant to a final project output format.

15. The system of claim 14, wherein said functionality for a user to switch views of the BD-ROM data structure includes
a first mechanism configured to hide different levels of underlying details of the BD-ROM data structure created by the user.

16. The system of claim 14, wherein said functionality for a user to switch views of the BD-ROM data structure includes
a second mechanism configured to expose different levels of underlying details of the BD-ROM data structure created by the user.

17. The system of claim 16, wherein said second mechanism presents only a few of high level BD-ROM data structures but exposes many simpler interconnected low level BD-ROM data structures.

18. The system of claim 14, wherein said abstractions represent
objects that are presentation oriented.

19. The system of claim 18, wherein objects include
playable contents, segments, scripts, clips, streams, events, interactive objects, and effects.

20. The system of claim 19, wherein playable contents include
playable content, a title, a menu, virtual playable content, a multi-story playable content, a multi-angle playable content, a single segment time-based slideshow, a multi-segment time-based slideshow, and a browsable slideshow.

21. The system of claim 20, wherein said abstraction module is configured to provide abstraction of the playable content that represents the basic playable entity including a Movie Object, a Playlist, PlayItems, and Clips.

22. The system of claim 20, wherein said abstraction module is configured to provide abstraction of the playable content that represents BD Java code, a Playlist, PlayItems, and Clips.

23. The system of claim 20, wherein said abstraction module is configured to provide abstraction of the virtual playable content that allows reuse of clips belonging to other playable contents.

24. The system of claim 20, wherein the interactive objects include
a Page Layer Composition (PLC), a Page Layer (PL), effects, and Buttons.

25. An apparatus for authoring a Blu-ray Disc, comprising:
means for providing abstractions that offer a functionality for a user to switch views of a BD-ROM data structure based on requirements and levels of expertise of the user; and
means for providing a mechanism to author projects independent of an underlying format compliant to a final project output format.

26. A computer program, stored in a computer-readable storage medium, for authoring a Blu-ray Disc, the program comprising executable instructions that cause a computer to:
provide abstractions that offer a functionality for a user to switch views of a BD-ROM data structure based on requirements and levels of expertise of the user; and
provide a mechanism to author projects independent of an underlying format compliant to a final project output format.
